(19) United States
(12) Patent Application Publication
(10) Pub. No.: US 2019/0066575 A1
(43) Pub. Date: Feb. 28, 2019

(54) OLED DISPLAY PANEL AND DRIVING METHOD FOR THE SAME AND DRIVING CIRCUIT

(71) Applicant: BOE Technology Group Co., Ltd., Beijing (CN)

(72) Inventor: Danna Song, Beijing (CN)

(21) Appl. No.: 15/962,060

(22) Filed: Apr. 25, 2018

(30) Foreign Application Priority Data
Aug. 30, 2017 (CN) 201710763453.3

(51) Int. Cl. G09G 3/3208

(52) U.S. Cl. CPC G09G 3/3208; G09G 3/3607

(57) ABSTRACT

The present disclosure proposes an OLED display panel, and a driving method and driving circuit thereof. After grayscale data of a pixel in an image to be displayed is acquired and aging degree of the pixel is determined, a data compensation coefficient of the pixel is determined according to both the grayscale data of the pixel and the aging degree of the pixel. Then, the grayscale data of the pixel is compensated using the determined data compensation coefficient. Finally, the pixel is driven using the compensated grayscale data.

### CROSS-REFERENCE TO RELATED APPLICATION(S)

This application claims priority to the Chinese Patent Application No. 201710763453.3, filed on Aug. 30, 2017, entitled “OLED DISPLAY PANEL AND DRIVING METHOD FOR THE SAME AND DRIVING CIRCUIT”, which is incorporated herein by reference in its entirety.

### TECHNICAL FIELD

The present disclosure relates to the field of liquid crystal displays, and more particularly, to an Organic Light-Emitting Diode (OLED) display panel, and a driving method and driving circuit thereof.

### BACKGROUND

OLED display devices have problems of lifetime degradation and aging as the usage time increases. The current solution to these problems is to compensate for the aged OLEDs using compensation coefficients for display. However, in the related compensation methods, the compensation coefficients are determined only using aging degree of pixels regardless of magnitude of input grayscales, which may result in poor compensation effects during low grayscale display.

### SUMMARY

The embodiments of the present disclosure provide a driving method of an OLED display panel. The driving method comprises: acquiring grayscale data of a pixel in an image to be displayed; determining aging degree of the pixel; determining a data compensation coefficient of the pixel according to the grayscale data of the pixel and the aging degree of the pixel; compensating for the grayscale data of the pixel using the determined data compensation coefficient; and driving the pixel using the compensated grayscale data.

In an embodiment, the step of determining a data compensation coefficient of the pixel further comprises: determining a corresponding data compensation coefficient as the data compensation coefficient of the pixel from a pre-established correspondence look-up table of grayscale data, aging degree and data compensation coefficients using the grayscale data of the pixel and the aging degree of the pixel.

In an embodiment, the step of determining a data compensation coefficient of the pixel further comprises: determining a corresponding grayscale gain value as a grayscale gain value of the pixel from a pre-established correspondence look-up table of grayscale data and grayscale gain values using the grayscale data of the pixel; determining a corresponding aging compensation coefficient as an aging compensation coefficient of the pixel from a pre-established correspondence look-up table of aging degree and aging compensation coefficients using the aging degree of the pixel; and determining the data compensation coefficient of the pixel according to the grayscale gain value of the pixel and the aging compensation coefficient of the pixel.

In an embodiment, the step of determining a data compensation coefficient of the pixel further comprises: using a result of multiplying the grayscale gain value of the pixel with the aging compensation coefficient of the pixel as the data compensation coefficient of the pixel.

In an embodiment, the step of determining a data compensation coefficient of the pixel further comprises: using a result of adding the grayscale gain value of the pixel to the aging compensation coefficient of the pixel as the data compensation coefficient of the pixel.

In an embodiment, the step of determining aging degree of the pixel further comprises: determining the aging degree of the pixel according to a display duration of the pixel.

In another aspect, the embodiments of the present disclosure further provide a driving circuit of an OLED display panel. The driving circuit comprises: an acquisition sub-circuit configured to acquire grayscale data of a pixel in an image to be displayed; a determination sub-circuit configured to determine aging degree of the pixel; a processing sub-circuit configured to determine a data compensation coefficient of the pixel according to the grayscale data of the pixel and the aging degree of the pixel; a compensation sub-circuit configured to compensate for the grayscale data of the pixel using the determined data compensation coefficient; and a driving sub-circuit configured to drive the pixel using the compensated grayscale data.

In an embodiment, the driving circuit further comprises: a first storage sub-circuit configured to store a pre-established correspondence look-up table of grayscale data, aging degree and data compensation coefficients, wherein the processing sub-circuit is further configured to determine a corresponding data compensation coefficient as the data compensation coefficient of the pixel from the pre-established correspondence look-up table of grayscale data, aging degree and data compensation coefficients using the grayscale data of the pixel and the aging degree of the pixel.

In an embodiment, the driving circuit further comprises: a second storage sub-circuit configured to store a pre-established correspondence look-up table of grayscale data and grayscale gain values; and a third storage sub-circuit configured to store a pre-established correspondence look-up table of aging degree and aging compensation coefficients. The processing sub-circuit further comprises: a first processing unit configured to determine a corresponding grayscale gain value as a grayscale gain value of the pixel from the pre-established correspondence look-up table of grayscale data and grayscale gain values using the grayscale data of the pixel; a second processing unit configured to determine a corresponding aging compensation coefficient as an aging compensation coefficient of the pixel from the pre-established correspondence look-up table of aging degree and aging compensation coefficients using the aging degree of the pixel; and a third processing unit configured to determine the data compensation coefficient of the pixel according to the grayscale gain value of the pixel and the aging compensation coefficient of the pixel.

In an embodiment, the third processing unit is further configured to use a result of multiplying the grayscale gain value of the pixel with the aging compensation coefficient of the pixel as the data compensation coefficient of the pixel.

In an embodiment, the third processing unit is further configured to use a result of adding the grayscale gain value of the pixel to the aging compensation coefficient of the pixel as the data compensation coefficient of the pixel.

In an embodiment, the determination sub-circuit is further configured to determine the aging degree of the pixel according to a display duration of the pixel.

In another aspect, the embodiments of the present disclosure further provide an OLED display panel, comprising the driving circuit described in the embodiments described above.

In another aspect, the embodiments of the present disclosure further provide a display apparatus, comprising the OLED display panel described in the embodiments described above.

### BRIEF DESCRIPTION OF THE DRAWINGS

FIG. 1 is a flowchart of a method for driving an OLED display panel according to an embodiment of the present disclosure;

FIG. 2 is a structural block diagram of a driving circuit of an OLED display panel according to an embodiment of the present disclosure;

FIG. 3 is a specific structural block diagram of a driving circuit of an OLED display panel according to an embodiment of the present disclosure; and

FIG. 4 is a specific structural block diagram of a driving circuit of an OLED display panel according to an embodiment of the present disclosure.

### DETAILED DESCRIPTION

Specific implementations of an OLED display panel, and a driving method and driving circuit thereof according to the embodiments of the present disclosure will be described in detail below with reference to the accompanying drawings.

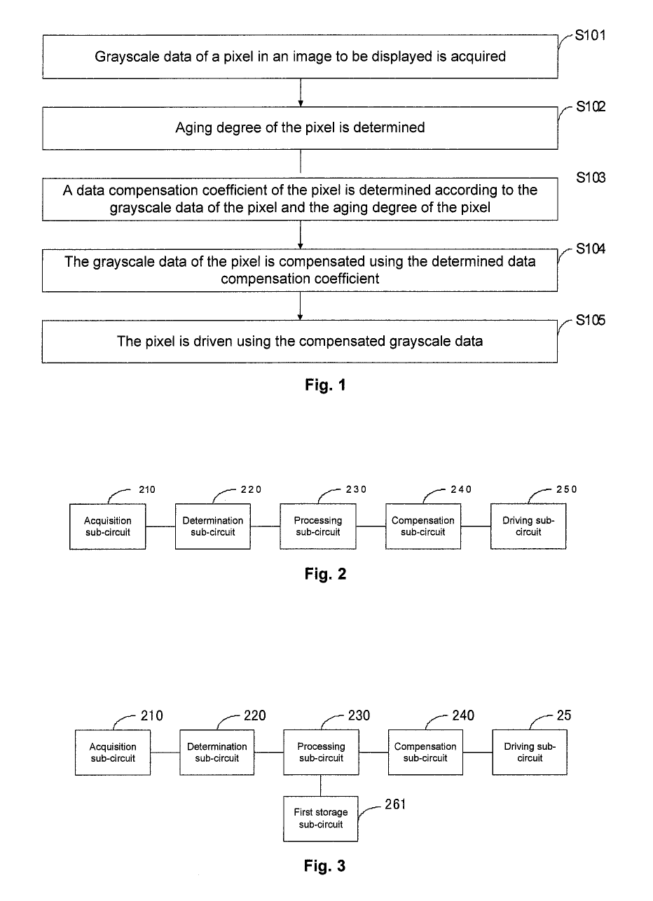

A driving method of an OLED display panel according to an embodiment of the present disclosure, as shown in FIG. 1, comprises the following steps.

In S101, grayscale data of a pixel in an image to be displayed is acquired.

In S102, aging degree of the pixel is determined.

In S103, a data compensation coefficient of the pixel is determined according to the grayscale data of the pixel and the aging degree of the pixel.

In S104, the grayscale data of the pixel is compensated using the determined data compensation coefficient.

In S105, the pixel is driven using the compensated grayscale data.

Specifically, the OLED display panel according to the embodiments of the present disclosure determines the data compensation coefficient using both the grayscale data and the aging degree of the pixel.

In a specific implementation, in the above-mentioned driving method according to the embodiments of the present disclosure, step S101 of acquiring the grayscale data of the pixel in the image to be displayed and step S102 of determining the aging degree of the pixel may be performed at the same time. In addition, a value range of the grayscale data acquired in step S101 is generally between 0 (inclusive) and 255 (inclusive), and the higher the value of the grayscale data, the higher the brightness required for display of the pixel.

In a specific implementation, in the above-mentioned driving method according to the embodiments of the present disclosure, determining aging degree of the pixel in step S102 may be specifically implemented by: determining the aging degree of the pixel according to display duration of the pixel. In general, the longer the display duration, the greater the aging degree. Specifically, if display durations of pixels belong to the same time period, these pixels may be determined to have the same aging degree. For example, when the display durations of the pixels are between 1 hour and 2 hours, the pixels are determined to correspond to the same aging degree.

Specifically, total display duration of the OLED display panel may be taken as display durations of the pixels, that is, the display durations of the pixels are the same in the same time period. This determination manner is a relatively simple operation, but the determination manner of the aging degree is not sufficiently accurate. Alternatively, the display durations of the pixels may also be calculated respectively, that is, depending on different display brightness of the pixels, the pixels may correspond to different display durations in the same time period. This determination manner of the aging degree is sufficiently accurate. For example, when the OLED display panel displays a dial plate with a dark background for a long time period, display durations of pixels provided in the background are much less than those of pixels provided in displayed numbers. Therefore, the aging degree of the pixels provided in the background are much less than those of the pixels provided in the displayed numbers in the same time period.

Generally, the data compensation coefficient may be determined according to the grayscale data in a case of the same aging degree, so that the smaller the grayscale data of the pixel, the higher the data compensation coefficient. In addition, the data compensation coefficient may be determined according to the aging degree in a case of the same grayscale data, so that the more severe the aging of the pixel, the higher the data compensation coefficient. In this way, the compensation effect for the more severe aging effect and the lower grayscale can be enhanced, so that the compensated OLED display panel has a relatively uniform display effect. In the above-mentioned driving method according to the embodiments of the present disclosure, in step S103, the smaller the grayscale data of the pixel, the higher the compensation coefficient may be assigned, and the higher the aging degree of the pixel, the higher the compensation coefficient may be assigned.

In the above-mentioned driving method according to the embodiments of the present disclosure, step S103 may be implemented by:

determining a corresponding data compensation coefficient as the data compensation coefficient of the pixel from a pre-established correspondence look-up table of grayscale data, aging degree, and data compensation coefficients using the grayscale data of the pixel and the aging degree of the pixel. That is, the correspondence look-up table of the grayscale data, the aging degree and the compensation coefficients may be pre-established and stored, and then the grayscale data and the aging degree may be input into the look-up table at the same time to find the corresponding data compensation coefficient.

Alternatively, step S103 may also be implemented by:

firstly, determining a corresponding grayscale gain value as a grayscale gain value of the pixel from a pre-established correspondence look-up table of grayscale data and grayscale gain values using the grayscale data of the pixel;

then determining a corresponding aging compensation coefficient as an aging compensation coefficient of the pixel from a pre-established correspondence look-up table of aging degree and aging compensation coefficients using the aging degree of the pixel; and

finally determining the data compensation coefficient of the pixel according to the grayscale gain value of the pixel and the aging compensation coefficient of the pixel.

Specifically, an aging compensation coefficient look-up table for the aging degree and a grayscale gain value look-up table for the grayscale data may be pre-established and stored, then the grayscale data may be input into in the grayscale gain value look-up table to find the grayscale gain value, and the aging degree is input into the aging compensation coefficient look-up table to find the aging compensation coefficient, and subsequently the final data compensation coefficient is calculated by performing a corresponding operation on the grayscale gain value and the aging compensation coefficient. As correspondences are established in the two look-up tables only for single look-up variables respectively, this way of determining the data compensation coefficient can realize a simple and rapid process of using the look-up tables.

In a specific implementation, in the above-mentioned driving method according to the embodiments of the present disclosure, the step of determining the grayscale gain value of the pixel and the aging compensation coefficient of the pixel may comprise:

using a result of multiplying the grayscale gain value of the pixel with the aging compensation coefficient of the pixel as the data compensation coefficient of the pixel; or

using a result of adding the grayscale gain value of the pixel to the aging compensation coefficient of the pixel as the data compensation coefficient of the pixel.

Based on the same concept, the embodiments of the present disclosure further provide a driving circuit of an OLED display panel. As the principle of the driving circuit to solve the problem is similar to that of the above-mentioned driving method of an OLED display panel, the implementation of the driving circuit can be known with reference to the driving method, and the repeated description is omitted.

Specifically, a driving circuit of an OLED display panel according to the embodiments of the present disclosure, as shown in FIG. 2, may specifically comprises: an acquisition sub-circuit 210 configured to acquire grayscale data of a pixel in an image to be displayed;

a determination sub-circuit 220 configured to determine aging degree of the pixel;

a processing sub-circuit 230 configured to determine a data compensation coefficient of the pixel according to the grayscale data of the pixel and the aging degree of the pixel;

a compensation sub-circuit 240 configured to compensate for the grayscale data of the pixel using the determined data compensation coefficient; and

a driving sub-circuit 250 configured to drive the pixel using the compensated grayscale data.

In a specific implementation, in the above-mentioned driving circuit according to the embodiments of the present disclosure, as shown in FIG. 3, the driving circuit may further comprise: a first storage sub-circuit 261 configured to store a pre-established correspondence look-up table of grayscale data, aging degree and data compensation coefficients.

Correspondingly, the processing sub-circuit 230 is further configured to determine a corresponding data compensation coefficient as the data compensation coefficient of the pixel from the pre-established correspondence look-up table of grayscale data, aging degree and data compensation coefficients using the grayscale data of the pixel and the aging degree of the pixel.

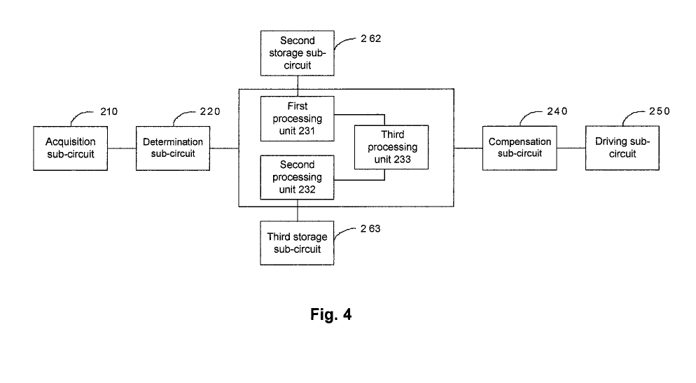

In a specific implementation, in the above-mentioned driving circuit according to the embodiments of the present disclosure, as shown in FIG. 4, the driving circuit may further comprise a second storage sub-circuit 262 configured to store a pre-established correspondence look-up table of grayscale data and grayscale gain values; and

a third storage sub-circuit 263 configured to store a pre-established correspondence look-up table of aging degree and aging compensation coefficients.

Correspondingly, the processing sub-circuit 230 further comprises:

a first processing unit 231 configured to determine a corresponding grayscale gain value as a grayscale gain value of the pixel from the pre-established correspondence look-up table of grayscale data and grayscale gain values using the grayscale data of the pixel;

a second processing unit 232 configured to determine a corresponding aging compensation coefficient as an aging compensation coefficient of the pixel from the pre-established correspondence look-up table of aging degree and aging compensation coefficients using the aging degree of the pixel; and

a third processing unit 233 configured to determine the data compensation coefficient of the pixel according to the grayscale gain value of the pixel and the aging compensation coefficient of the pixel.

In a specific implementation, in the above-mentioned driving circuit according to the embodiments of the present disclosure, the third processing unit 233 may further be configured to use a result of multiplying the grayscale gain value of the pixel with the aging compensation coefficient of the pixel as the data compensation coefficient of the pixel, or use a result of adding the grayscale gain value of the pixel to the aging compensation coefficient as the data compensation coefficient of the pixel.

In a specific implementation, in the above-mentioned driving circuit according to the embodiments of the present disclosure, the determining sub-circuit 220 is further configured to determine the aging degree of the OLED display panel according to a display duration of the OLED display panel.

Based on the same concept, the embodiments of the present disclosure further provide an OLED display panel comprising the above-mentioned driving circuit according to the embodiments of the present disclosure.

Based on the same conception, the embodiments of the present disclosure further provide a display apparatus comprising the above-mentioned OLED display panel according to the embodiments of the present disclosure. The display apparatus may be any product or component having a display function, such as a mobile phone, a tablet computer, a television, a display, a notebook computer, a digital photo frame, a navigator etc. The implementation of the display apparatus can be known with reference to the above-mentioned embodiments of the OLED display panel, and the repeated description is omitted.

With the above description of the implementations, it can be clearly understood by those skilled in the art that the embodiments of the present disclosure can be implemented by hardware, and can also be implemented by means of software and a necessary general hardware platform. Based on this understanding, the technical solutions according to the embodiments of the present disclosure can be embodied in a form of a software product which can be stored in a non-volatile storage medium (for example, a CD-ROM, a U disk, a removable hard disk, etc.) including several instructions to enable a computer device (for example, a personal computer, a server, or a network device, etc.) to perform the methods described in the various embodiments of the present disclosure.

It can be understood by those skilled in the art that the accompanying drawings are only block diagrams of a preferred embodiment, and sub-circuits or flows in the accompanying drawings are not necessarily required to implement the present disclosure.

It can be understood by those skilled in the art that sub-circuits in a circuit in an embodiment may be distributed in the circuit of the embodiment according to the description of the embodiment, or may also be located in one or more circuits different from that in the present embodiment. The sub-circuits of the above embodiment may be combined into one sub-circuit or may be further split into multiple smaller sub-circuits.

Sequence numbers of the above embodiments of the present disclosure are only for description, and do not represent advantages and disadvantages of the embodiments.

In the OLED display panel, and the driving method and the driving circuit thereof according to the embodiments of the present disclosure, after the grayscale data of the pixel in the image to be displayed is acquired and the aging degree of the pixel is determined, the data compensation coefficient of the pixel is determined according to both the grayscale data of the pixel and the aging degree of the pixel. Then the grayscale data of the pixel is compensated using the determined data compensation coefficient of the pixel. Finally, the pixel in the OLED display panel is driven using the compensated grayscale data of the pixel. As the data compensation coefficient is determined using both the grayscale data and the aging degree of the pixel, the data compensation coefficient can be determined according to the grayscale data in a case of the same aging degree, so that the smaller the grayscale data of the pixel, the higher the data compensation coefficient. In this way, the compensation effect for the more severe aging effect and the lower grayscale can be enhanced, so that the compensated OLED display panel has a relatively uniform display effect.

It will be apparent to those skilled in the art that various modifications and variations can be made in the present disclosure without departing from the spirit and scope of the present disclosure. Thus, if these modifications and variations of the present disclosure fall within the scope of the claims of the present disclosure and equivalents thereof, these modifications and variations are also intended to be included in the present disclosure.

I/we claim:

1. A driving method of an OLED display panel, comprising:
acquiring grayscale data of a pixel in an image to be displayed;
determining aging degree of the pixel;
determining a data compensation coefficient of the pixel according to the grayscale data of the pixel and the aging degree of the pixel;
compensating for the grayscale data of the pixel using the determined data compensation coefficient; and
driving the pixel using the compensated grayscale data.

2. The driving method according to claim 1, wherein the step of determining a data compensation coefficient of the pixel further comprises:
determining a corresponding data compensation coefficient as the data compensation coefficient of the pixel from a pre-established correspondence look-up table of grayscale data, aging degree and data compensation coefficients using the grayscale data of the pixel and the aging degree of the pixel.

3. The driving method according to claim 1, wherein the step of determining a data compensation coefficient of the pixel further comprises:
determining a corresponding grayscale gain value as a grayscale gain value of the pixel from a pre-established correspondence look-up table of grayscale data and grayscale gain values using the grayscale data of the pixel;
determining a corresponding aging compensation coefficient as an aging compensation coefficient of the pixel from a pre-established correspondence look-up table of aging degree and aging compensation coefficients using the aging degree of the pixel; and
determining the data compensation coefficient of the pixel according to the grayscale gain value of the pixel and the aging compensation coefficient of the pixel.

4. The driving method according to claim 3, wherein the step of determining a data compensation coefficient of the pixel further comprises:
using a result of multiplying the grayscale gain value of the pixel with the aging compensation coefficient of the pixel as the data compensation coefficient of the pixel.

5. The driving method according to claim 3, wherein the step of determining a data compensation coefficient of the pixel further comprises:
using a result of adding the grayscale gain value of the pixel to the aging compensation coefficient of the pixel as the data compensation coefficient of the pixel.

6. The driving method according to claim 1, wherein the step of determining aging degree of the pixel further comprises:
determining the aging degree of the pixel according to a display duration of the pixel.

7. A driving circuit of an OLED display panel, comprising:
an acquisition sub-circuit configured to acquire grayscale data of a pixel in an image to be displayed;
a determination sub-circuit configured to determine aging degree of the pixel;
a processing sub-circuit configured to determine a data compensation coefficient of the pixel according to the grayscale data of the pixel and the aging degree of the pixel;
a compensation sub-circuit configured to compensate for the grayscale data of the pixel using the determined data compensation coefficient; and
a driving sub-circuit configured to drive the pixel using the compensated grayscale data.

8. The driving circuit according to claim 7, further comprising: a first storage sub-circuit configured to store a pre-established correspondence look-up table of grayscale data, aging degree and data compensation coefficients,
wherein the processing sub-circuit is further configured to determine a corresponding data compensation coefficient as the data compensation coefficient of the pixel from the pre-established correspondence look-up table of grayscale data, aging degree and data compensation coefficients using the grayscale data of the pixel and the aging degree of the pixel.

9. The driving circuit according to claim 7, further comprising:
a second storage sub-circuit configured to store a pre-established correspondence look-up table of grayscale data and grayscale gain values; and
a third storage sub-circuit configured to store a pre-established correspondence look-up table of aging degree and aging compensation coefficients,
wherein the processing sub-circuit further comprises:
a first processing unit configured to determine a corresponding grayscale gain value as a grayscale gain value of the pixel from the pre-established correspondence look-up table of grayscale data and grayscale gain values using the grayscale data of the pixel;
a second processing unit configured to determine a corresponding aging compensation coefficient as an aging compensation coefficient of the pixel from the pre-established correspondence look-up table of aging degree and aging compensation coefficients using the aging degree of the pixel; and
a third processing unit configured to determine the data compensation coefficient of the pixel according to the grayscale gain value of the pixel and the aging compensation coefficient of the pixel.

10. The driving circuit according to claim 9, wherein the third processing unit is further configured to use a result of multiplying the grayscale gain value of the pixel with the aging compensation coefficient of the pixel as the data compensation coefficient of the pixel.

11. The driving circuit according to claim 9, wherein the third processing unit is further configured to use a result of adding the grayscale gain value of the pixel to the aging compensation coefficient of the pixel as the data compensation coefficient of the pixel.

12. The driving circuit according to claim 7, wherein the determination sub-circuit is further configured to determine the aging degree of the pixel according to a display duration of the pixel.

13. An OLED display panel, comprising the driving circuit according to claim 7.

14. A display apparatus, comprising the OLED display panel according to claim 13.

15. An OLED display panel, comprising the driving circuit according to claim 8.

16. An OLED display panel, comprising the driving circuit according to claim 9.

17. An OLED display panel, comprising the driving circuit according to claim 10.

18. An OLED display panel, comprising the driving circuit according to claim 11.

19. A display apparatus, comprising the OLED display panel according to claim 16.

20. A display apparatus, comprising the OLED display panel according to claim 17.
